(19) United States
(12) Patent Application Publication
(10) Pub. No.: US 2007/0177604 A1
(43) Pub. Date: Aug. 2, 2007

(54) Network system for managing QoS

(75) Inventors: Yoji Ozawa, Hachioji (JP); Hideki Okita, Kokubunji (JP); Takashi Sumiyoshi, Kokubunji (JP); Kenichi Sakamoto, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/642,911

(22) Filed: Dec. 21, 2006

(30) Foreign Application Priority Data
Feb. 2, 2006 (JP) 2006-025858

(51) Int. Cl. H04L 12/56; H04L 12/26

(52) U.S. Cl. 370/395.2; 370/230

(57) ABSTRACT

The invention reduces the initial setting cost, the management cost, and reconfiguration cost of QoS guarantee for network devices. A management device has a control unit and the storage unit. The control unit obtains the number of terminals contained in the network system and connection relations of the network system at the time of initial setting for QoS guarantee. A control unit stores an operation policy which an administrator inputs. The control unit creates QoS control configuration for each connection path between adjacent two network devices using the number of terminals in the network system, the connection relations, and the operation policy. And QoS control configuration is the information for controlling the QoS guarantee of network devices. And the control unit sets the QoS control configuration in the network devices.

### CLAIM OF PRIORITY

The present application claims priority from Japanese patent application 2006-025858 filed on Feb. 2, 2006, the content of which is hereby incorporated by reference into this application.

### BACKGROUND OF THE INVENTION

This invention relates to a management device that automatically creates and sets settings about a guarantee of quality of service (QoS), and a network system composed of an information communication network.

IP networks and other packet switched networks that are used in corporations and the like are composed of various network communication devices including routers, switches, gateways, and access points.

The recent increase in number and type of devices constituting a network and diversification of services provided through networks have led to an increase in type and quantity of settings for properly running and managing a network.

To introduce a new service or device into an existing network, the administrator/builder of the network collects information of the network and creates a topology (connection relations in a network system) or the like to understand the current settings and state of the network. The network administrator/builder then chooses a device or interface (I/F) to be set, determines settings specific to the device to be set, and sets the settings in the device to be set.

The work cost of introducing a new service is thus great and constitutes a considerable burden on the network administrator/builder.

Services provided through networks include audio and video communication tools, for example, VoIP, video phone, and video conferencing. Such communication tools are required to be on a real-time basis. Accordingly, to make services involving such communication tools usable, delay has to be prevented and jitters have to be reduced by setting a QoS guarantee to the network.

One way to guarantee QoS is to allocate a dedicated bandwidth to a flow to be guaranteed. In carrying out this method, the administrator/builder of a network needs to understand the topology of the network and consider the expected utilization including how many communication sessions will be there when the network is put into operation, before determining a guaranteed bandwidth for each I/F and setting individual network devices separately.

Estimating the network utilization is necessary particularly when communication devices are set for initial introduction of a service. The network utilization is estimated based on the experiences of the network administrator/builder, or by setting up a trial period for the service to be introduced. Based on the estimation, the network administrator/builder creates settings for each I/F. The work of determining settings and setting the settings after understanding the topology of a network and estimating the network utilization is thus a great burden to the administrator/builder of the network.

This problem has been addressed by, for example, a path bandwidth setting method disclosed in JP 2004-364181 A. In this method, a VoIP call agent cooperates with a network management agent, which monitors the path capacity so that a connection is allowed to be established as long as the path capacity is not exceeded while a connection establishment request that is above the path capacity is rejected. The network management agent observes the call loss rate performance in a path to monitor for degradation of the call loss rate performance and an overquality state, estimates the optimum call loss rate characteristics, and changes the path capacity based on an estimated path capacity.

This method disclosed in JP 2004-364181 A changes settings, while a network is in operation, in a manner that satisfies a requested call loss rate performance, and thereby guarantees QoS of VoIP.

### SUMMARY OF THE INVENTION

However, the method disclosed in JP 2004-364181 A is a method specialized for multi protocol label switching (MPLS) networks.

In MPLS networks, a path capacity is set by setting only an edge node. MPLS networks are advantageous in this regard but, since they are a network technology mainly for backbone networks, are not suitable for uses as an interoffice LAN or other general networks. Further, to guarantee QoS of a network that is used as an interoffice LAN or the like, priority control, guaranteed bandwidth control, and other settings for QoS guarantee control specific to each I/F have to be set separately for all network devices constituting the network of which QoS is to be guaranteed.

The method according to JP 2004-364181 A is therefore not suitable for networks used in corporations. The method also puts a very heavy burden on the administrator/builder of a network in terms of the work cost for creating settings for each I/F and executing the created settings because the appropriate setting value (of the guaranteed bandwidth or the like) specific to each I/F varies depending on the topology and operation state of the network.

The method disclosed in JP 2004-364181 A also produces, in the network management device (the network management agent), each time a communication session is created, processing of estimating the utilization, or creating QoS guarantee settings based on the estimated utilization and executing the created settings. This processing constitutes a heavy load on the network management device, thus making it difficult to apply the method to large-scale networks and networks where the phone call count is high.

Further, the introduction and running of a service that needs a QoS guarantee in a corporation's network requires a great setting work cost from the administrator/builder of the network upon initial introduction of the service. There are also the risks of wrong setting and failure to set in networks that are used in corporations and whose configurations are changed frequently by addition of components or from other similar reasons.

This invention has been made in view of the above problems, and it is therefore an object of this invention to automatically set QoS guarantee settings for each I/F of network devices in order to guarantee the communication quality of flows including an audio flow and a video flow in a network that is used in a corporation or the like.

More specifically, an object of this invention is to cut the work cost to a network administrator/builder by automating QoS guarantee setting upon initial setting, to allocate bandwidth resources efficiently by automating QoS setting during operation, to reduce the load on a network management device by automatic QoS guarantee setting, and to decrease risks in changing the network configuration such as wrong setting and failure to set.

To solve the above-mentioned problem, according to an aspect of this invention, there is provided a management device, which is included in a network system that contains at least one terminal that sends and receives at least one of audio data and video data as a data flow, and at least one network device that transfers the data flow sent and received by the terminals while guaranteeing QoS of the data flow, and which manages QoS guarantee control that is executed by the network devices, the management device comprising: a control unit; and a storage unit, in which, the control unit is configured to: obtain the number of terminals contained in the network system and connection relations in the network system when QoS control is about to start in the network system; store, in the storage unit, an operation policy entered by an administrator; use the number of terminals in the network system, the connection relations, and the operation policy to create, for each of a connection path between adjacent two of the network devices or for each of a connection path between one of the network devices and one of the terminals that is adjacent to the network device, QoS control information for controlling the QoS guarantee that is executed by the network devices; and set the created QoS control information for each I/F connected to the path between adjacent two of the network devices in the network devices.

According to this invention, a network management device automatically creates settings and sets the created settings in a network device when QoS control of a network is started. The cost to an administrator can thus be cut, and the possibilities of wrong setting and failure to set are reduced.

### BRIEF DESCRIPTION OF THE DRAWINGS

The present invention can be appreciated by the description which follows in conjunction with the following figures, wherein:

FIG. 1 is a configuration block diagram of a network management system according to an embodiment of this invention;

FIG. 2 is a configuration block diagram of a management device;

FIG. 3 is an explanatory diagram of an example of an operation policy;

FIG. 4 is an explanatory diagram of an example of a system parameter;

FIG. 5 is a configuration block diagram of a network device;

FIG. 6 is a configuration block diagram of a personal computer;

FIG. 7 is a sequence diagram showing how the network management system operates upon initial setting;

FIGS. 8A to 8D are explanatory diagrams with FIG. 8A showing an example of network device information, FIG. 8B showing an example of personal computer information, FIG. 8C showing an example of a setting request, and FIG. 8D showing an example of a guaranteeing flow definition setting request;

FIG. 9 is an explanatory diagram of an example of an access log;

FIG. 10 is a flow chart for settings creating processing of the management device;

FIG. 11 is a flow chart for processing of the network device;

FIG. 12 is a flow chart for agent program processing of the personal computer;

FIG. 13 is an explanatory diagram showing an example of settings;

FIG. 14 is an explanatory diagram of an example of number of terminals;

FIGS. 15A and 15B are explanatory diagrams each showing an example of QoS control information as a part of settings;

FIG. 16 is an explanatory diagram of an example of QoS control information that is held by each I/F of the network device;

FIG. 17 is an explanatory diagram showing an example of a GUI screen of the management device;

FIG. 18 is a sequence diagram for when the network management system is in operation;

FIG. 19 is an explanatory diagram showing an example of a session log;

FIG. 20 is a flow chart for settings updating processing of the management device;

FIG. 21 is a configuration block diagram of the network management system after a change in network configuration; and

FIG. 22 is a sequence diagram of the network management system after a change in network configuration.

### DETAILED DESCRIPTION OF THE PREFERRED EMBODIMENTS

An embodiment of this invention will be described below with reference to the accompanying drawings.

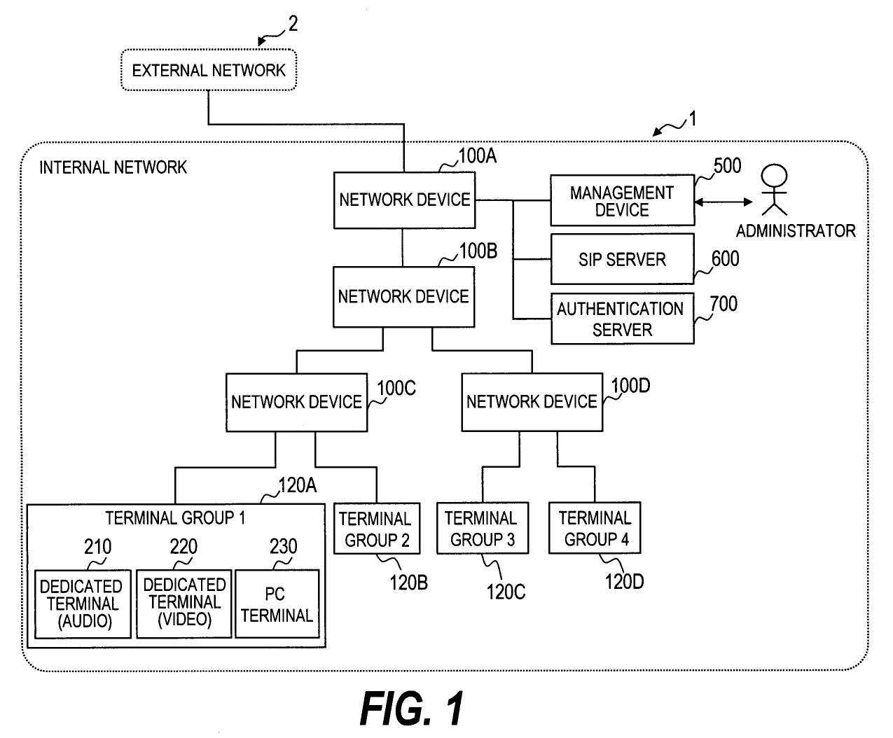

FIG. 1 is a configuration block diagram of a network management system according to the embodiment of this invention.

The network management system of FIG. 1 is composed of an internal network 1 and an external network 2 which are connected to each other. The internal network 1 is managed by an administrator. The external network 2 is a network that is not managed by the administrator.

The internal network 1 contains network devices 100 (100A to 100D), terminal groups 120 (120A to 120D), a management device 500, a session initiation protocol (SIP) server 600, and an authentication server 700.

Each network device 100 transfers a packet sent from a device or a terminal within the internal network 1 to the packet's intended destination. The network device 100 also executes control for guaranteeing QoS of the packet transferred.

Each terminal group 120 contains one or more terminals. Terminals in the terminal group 120 include at least one of a dedicated terminal 210 which can handle audio alone, a dedicated terminal 220 which can handle both audio and video, and a personal computer 230 working as a terminal which can handle audio or video by way of softphone or the like. These terminals may be connected to one another in the terminal group 120 by a network device that does not have a QoS control function (e.g., a switch or a hub).

The management device 500 manages devices and terminals contained in the internal network 1. More specifically, when QoS guarantee control is started following the construction of the internal network 1, the management device 500 calculates the topology and number of connected terminals of the network, creates network settings for a QoS guarantee, and delivers the created settings to the network devices 100 or the terminals.

The SIP server 600 controls a communication session held between terminals that are contained in the internal network 1 or the external network 2.

The authentication server 700 controls authentication of terminals contained in the internal network 1. In other words, terminals in the internal network 1 can communicate with each other only after being authenticated by the authentication server 700.

In the thus structured network management system, the following processing is executed.

The terminals mentioned above executes audio and video communications that are required to be on a real-time basis, such as VoIP, video phone, and video conferencing. To enable the terminals to execute the communications, the management device 500 sets settings for QoS guarantee control in the network devices and terminals contained in the internal network 1.

The management device 500 sets settings for QoS guarantee control which are different in an audio flow and a video flow.

An audio flow is required to have less delay and fewer jitters. The management device 500 therefore gives a high priority level to an audio flow and performs priority control with guaranteed QoS.

A video flow, on the other hand, is more tolerant of delay and jitters than an audio flow. However, a video flow uses a wider bandwidth than an audio flow. Giving a high priority level to a video flow and performing priority control as QoS guarantee control therefore has a possibility of oppressing and ultimately cutting other flows. Accordingly, QoS guarantee settings that guarantee the lowest bandwidth are chosen for a video flow instead of priority control. This means that a designated bandwidth is secured for a video flow and that a flow within the secured bandwidth is transferred preferentially while a flow equal to or more than the secured bandwidth is transferred at a priority level equal to that of a non-guaranteed flow.

Thus differentiating QoS guarantee control on an audio flow from QoS guarantee control on a video flow makes it possible to guarantee QoS of audio in a network that does not have enough bandwidth for a video flow.

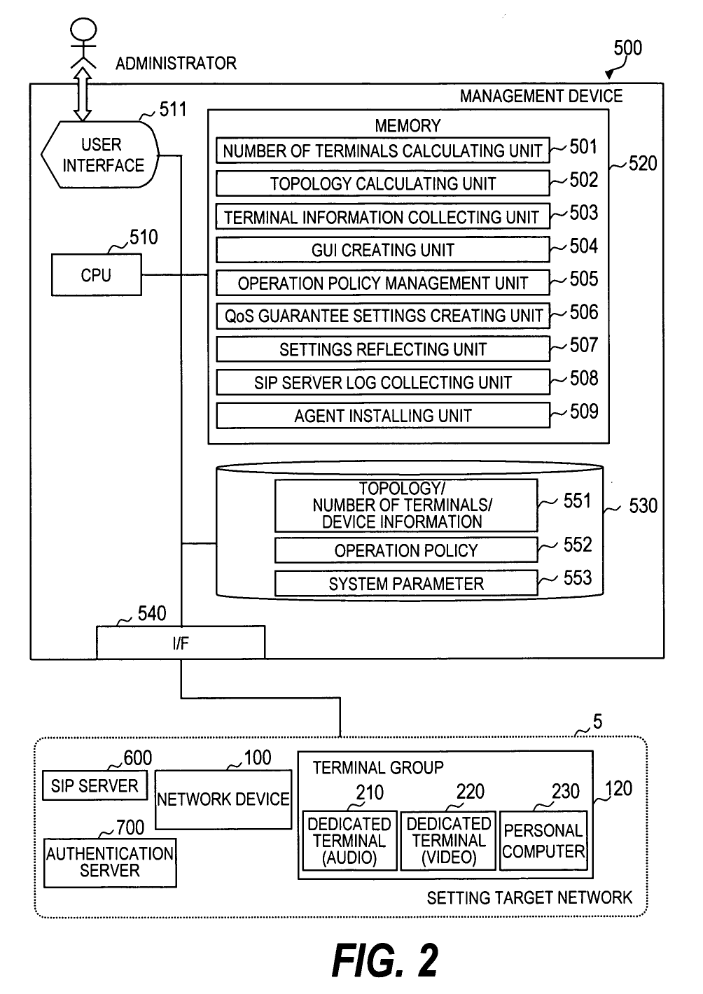

FIG. 2 is a configuration block diagram of the management device 500.

The management device 500 manages settings for QoS guarantee control of the devices and the terminals in the internal network 1.

The management device 500 contains a CPU 510, a memory 520, a disk device 530, a user interface 511, and an interface (I/F) 540.

The CPU 510 takes charge of processing executed in the management device 500. The CPU 510 reads and executes various programs and the like stored in the memory 520, to thereby execute processing defined in the programs.

The memory 520 stores a topology calculating unit 502, a terminal information collecting unit 503, a number of the terminals calculating unit 501, an operation policy management unit 505, a GUI creating unit 504, an agent installing unit 509, an SIP server log collecting unit 508, a settings creating unit 506, and a settings reflecting unit 507. These are stored as programs.

The disk device 530 stores topology/number of terminals/device information 551, an operation policy 552, and a system parameter 553. These are managed by the above programs.

The user interface 511 presents a graphical user interface (GUI) to the administrator. The user interface 511 displays settings information of the management device 500 and receives information entered by the administrator.

The I/F 540 is connected to the network and exchanges data with other devices, terminals, and the like to which the I/F 540 is connected via the network.

The thus structured management device 500 executes control for QoS guarantee control on the devices and the terminals (hereinafter also referred to as setting target network 5) that are contained in the internal network 1.

The setting target network 5 contains the network device 100, the terminal group 120, the SIP server 600, and the authentication server 700. FIG. 2 shows one network device 100 and one terminal group 120, but the setting target network 5 may contain a plurality of network devices 100 and terminal groups 120.

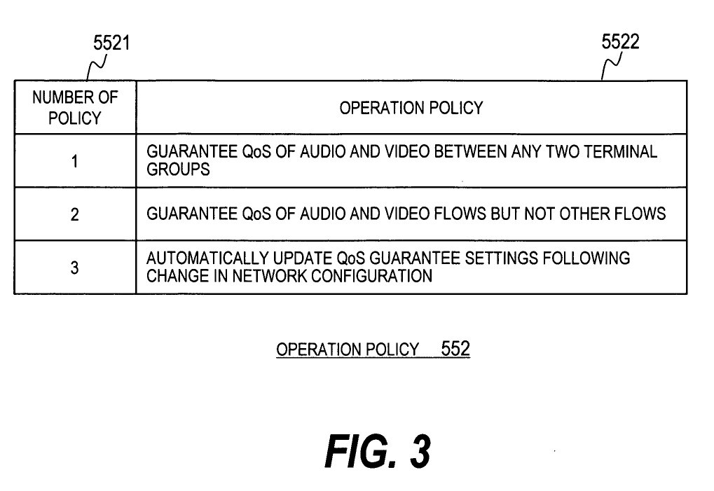

FIG. 3 is an explanatory diagram of an example of the operation policy 552, which is stored in the disk device 530.

The operation policy 552 contains a number field 5521 and an operation policy field 5522. The number field 5521 holds the identifier of an operation policy. The operation policy field 5522 holds the contents of the operation policy. The operation policy is set by the administrator.

Specifically, FIG. 3 shows that an operation policy for which “1” is held in the number field 5521 instructs to guarantee QoS of an audio flow and a video flow in communications among all terminal groups. An operation policy for which “2” is held in the number field 5521 instructs to guarantee QoS of an audio flow and a video flow but not other flows. An operation policy for which “3” is held in the number field 5521 instructs to automatically update QoS guarantee settings when the network configuration is changed (for instance, when a new network device is added).

An operation policy does not need to contain the topology and current settings of the network.

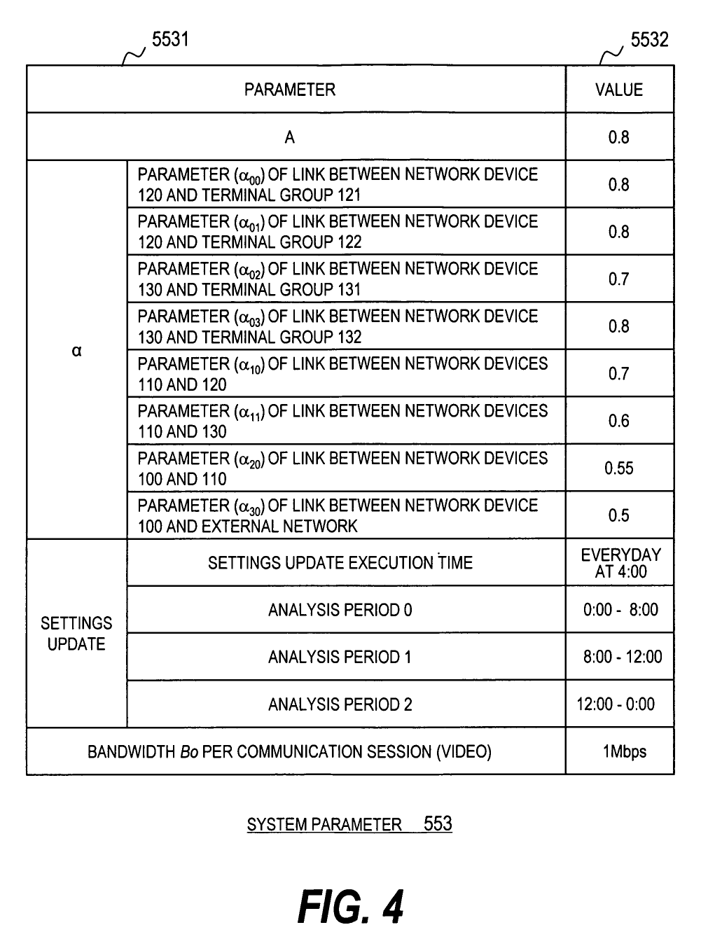

FIG. 4 is an explanatory diagram of an example of the system parameter 553, which is stored in the disk device 530.

The system parameter 553 contains a parameter field 5531 and a value field 5532. The parameter field 5531 holds information indicating a parameter. The value field 5532 holds an associated parameter value.

“A”, “α”, “settings update”, “bandwidth per communication session”, and the like are stored as parameters.

The parameter A and the parameter α each have a value larger than 0 and equal to or smaller than 1. The parameter α is a parameter that indicates the network operation state such as the utilization ratio of a link, and is preset in the management device 500 by the administrator when the internal network 1 is built.

For example, FIG. 4 shows that a value “0.8” is given to the parameter “A” in the parameter field 5531.

For the parameter “settings update”, a settings update execution time and analysis period of when the system is in operation which will be described later are stored.

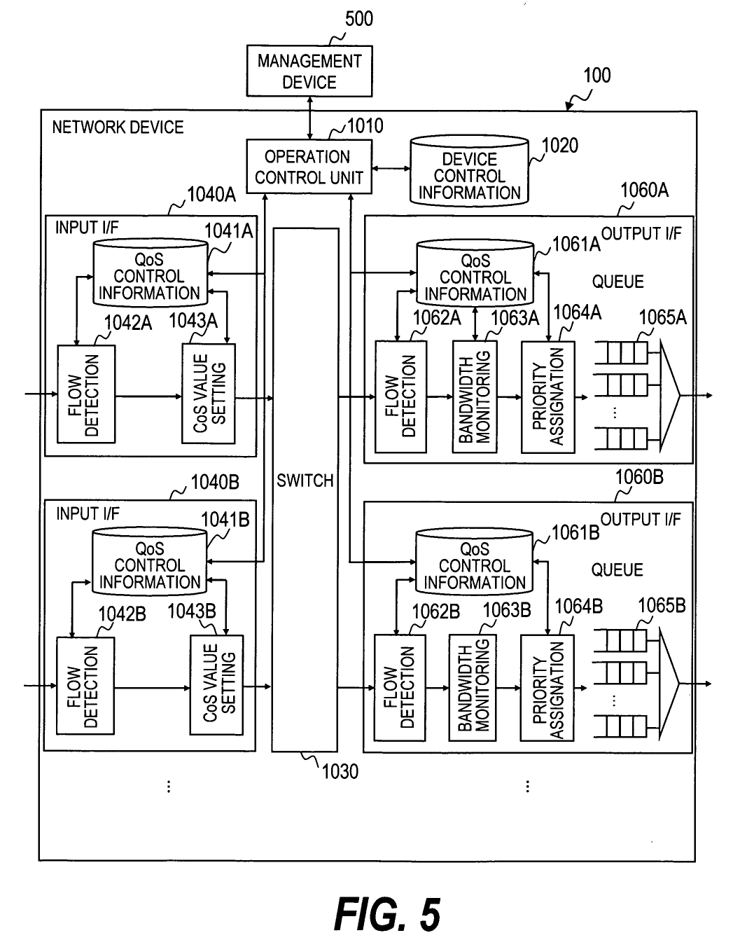

FIG. 5 is a configuration block diagram of the network device 100.

The network device 100 contains a plurality of input interfaces (I/Fs) 1040 (1040A, 1040B . . . ), a plurality of output interfaces (I/Fs) 1060 (1060A, 1060B . . . ), a switch 1030, an operation control unit 1010, and a device control information holding unit 1020.

The input I/Fs 1040 receive packets sent from other terminals, devices, a server, and the like via the network, and send the received packets to the switch 1030. The switch 1030 sends the received packets to the output I/Fs 1060. The output I/Fs 1060 send the received packets to the network.

The operation control unit 1010 controls processing that the network device 100 executes. The device control information holding unit 1020 stores device control information used by the operation control unit 1010.

Each input I/F 1040 contains a QoS control information holding unit 1041, a flow detecting unit 1042, and a CoS (Class of Service) value setting unit 1043.

The flow detecting unit 1042 detects audio flows and video flows sent from terminals. The CoS value setting unit 1043 sets different CoS values to an audio flow and a video flow that are detected by the flow detecting unit 1042 to discriminate one from other. The QoS control information holding unit 1041 stores QoS control information, which is information used by the flow detecting unit 1042 and the CoS value setting unit 1043.

Each output I/F 1060 contains a QoS control information holding unit 1061, a flow detecting unit 1062, a bandwidth monitoring unit 1063, a priority assigning unit 1064, and a queue 1065.

The flow detecting unit 1062 detects audio flows and video flows sent from the switch 1030. The bandwidth monitoring unit 1063 monitors the bandwidth of the output I/F 1060, and sets the bandwidths of the detected flows. The priority assigning unit 1064 sets priority levels to transmission packets and sends the packets to the queue 1065. The queue 1065 sends the received packets in an order determined by the set bandwidths or priority levels. The QoS control information holding unit 1061 stores QoS control information, which is information used by the flow detecting unit 1062, the bandwidth monitoring unit 1063, and the priority assigning unit 1064.

Having this configuration, the network device 100 controls a QoS guarantee of an audio flow and a video flow through transmission and reception of packets.

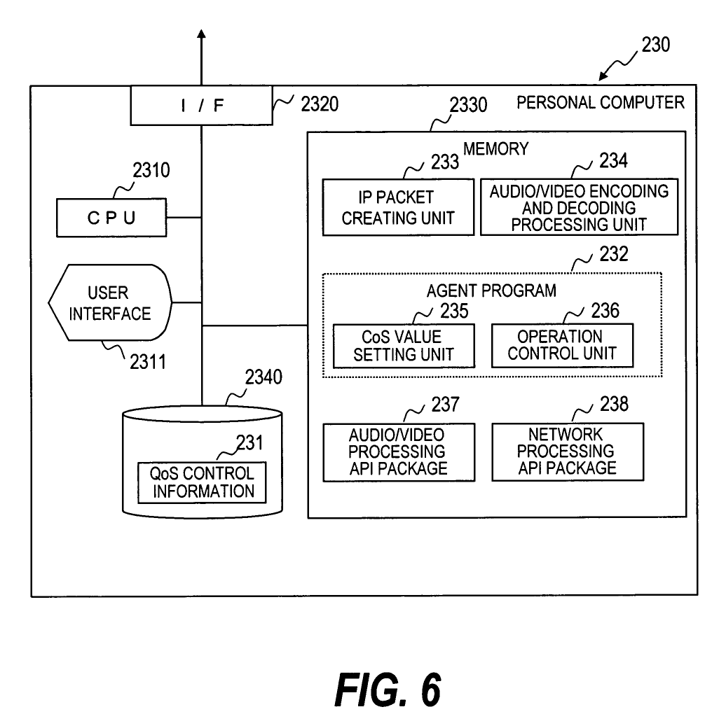

FIG. 6 is a configuration block diagram of the personal computer 230.

The personal computer 230 contains a CPU 2310, an interface (I/F) 2320, a memory 2330, a disk device 2340, and a user interface 2311.

The CPU 2310 takes charge of processing executed in the personal computer 230. The CPU 2310 reads and executes various programs and the like stored in the memory 2330, to thereby execute processing defined in the programs.

The I/F 2320 is connected to the network and exchanges data with other devices, terminals, and the like to which the I/F 2320 is connected via the network.

The memory 2330 stores, in the form of programs, an IP packet creating unit 233, which creates an IP packet containing audio/video data, an audio/video encoding and decoding processing unit 234, which processes audio/video inputted and outputted via the user interface 2311, a CoS value setting unit 235, which sets a CoS value to a created IP packet, an operation control unit 236, which responds to an information request from the management device 500 by regulating the operation of an agent program 232 in accordance with an operation setting request, a audio/video processing application program interface (API) package 237, and a network processing API package 238. The agent program 232 contains the CoS value setting unit 235 and the operation control unit 236. The agent program 232 is installed by the management device 500.

The disk device 2340 stores QoS control information 231 and other types of information. The stored information is managed by the operation control unit 236 described above.

The user interface 2311 outputs audio, video, and other types of data to a user of the personal computer 230, and accepts audio, video, and other types of data entered by the user.

The above programs stored in the memory 2330 enables a user of the personal computer 230 to have video and audio communications through the personal computer 230.

The operation control unit 236 sends information of a flow used by this personal computer 230 to the management device 500. Audio/video packets having CoS values set by the agent program 232 are sent outside via the I/F 2320.

Described next is how the thus structured network management system operates in the embodiment of this invention.

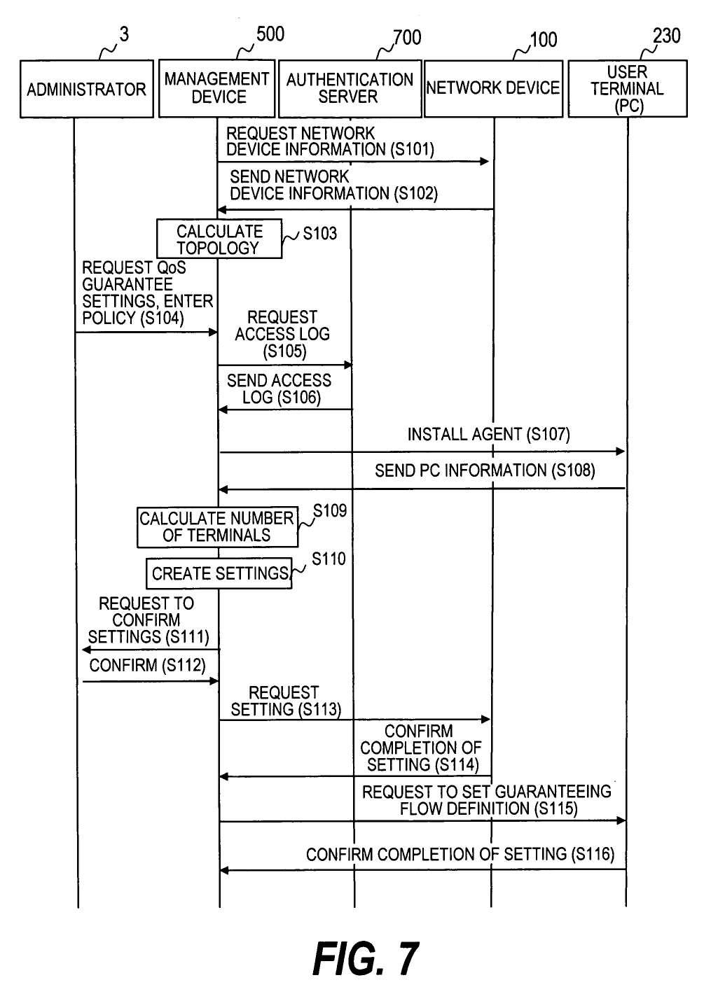

FIG. 7 is a sequence diagram of the operation upon initial setting of the network management system.

It should be noted that the physical configuration of the network, namely, the network configuration shown in FIG. 1, has already been completed at this point. The sequence of FIG. 7 is started after the terminals (dedicated terminals and personal computers) in the internal network 1 are put through authentication processing by the authentication server 700.

First, the management device 500 obtains information of the network device 100 in order to comprehend the topology of the network and functions of the network device 100. Specifically, the management device 500 requests network device information (S101). Receiving the request, the network device 100 sends network device information to the management device 500 which has sent the request (S102).

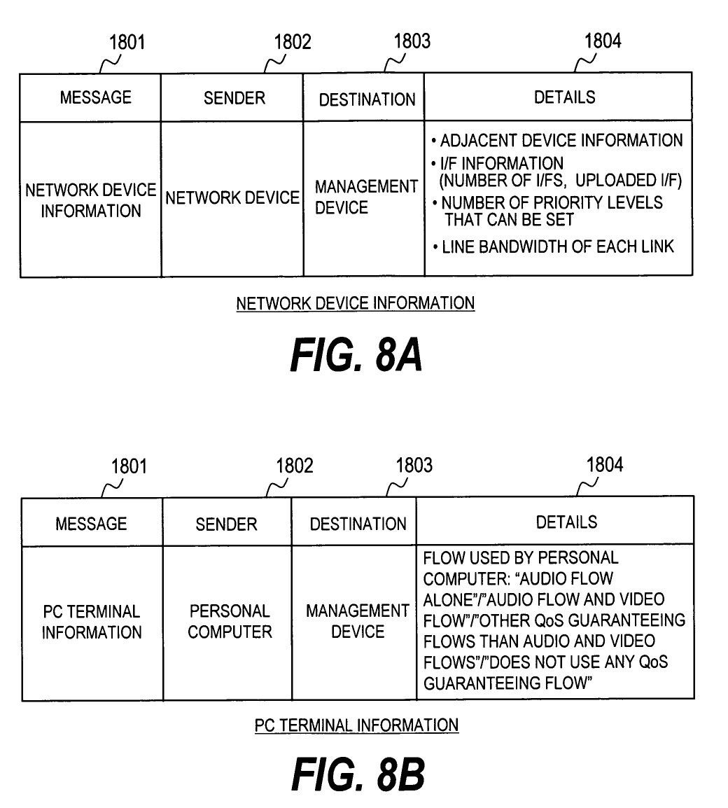

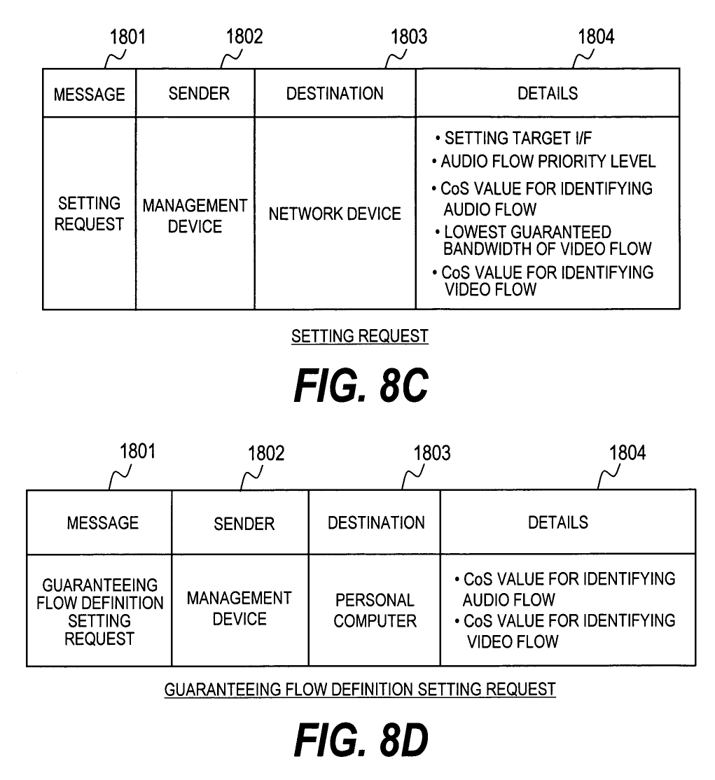

The network device information sent here contains adjacent device information, I/F information, the count of priority levels that can be set by this network device 100, the line bandwidth of each link, and the like as shown in FIG. 8A.

The management device 500 next calculates the topology of the network from the network device information obtained from the network device 100 (S103).

The administrator requests QoS guarantee settings in the management device 500. The administrator also sets an operation policy at this point (S104).

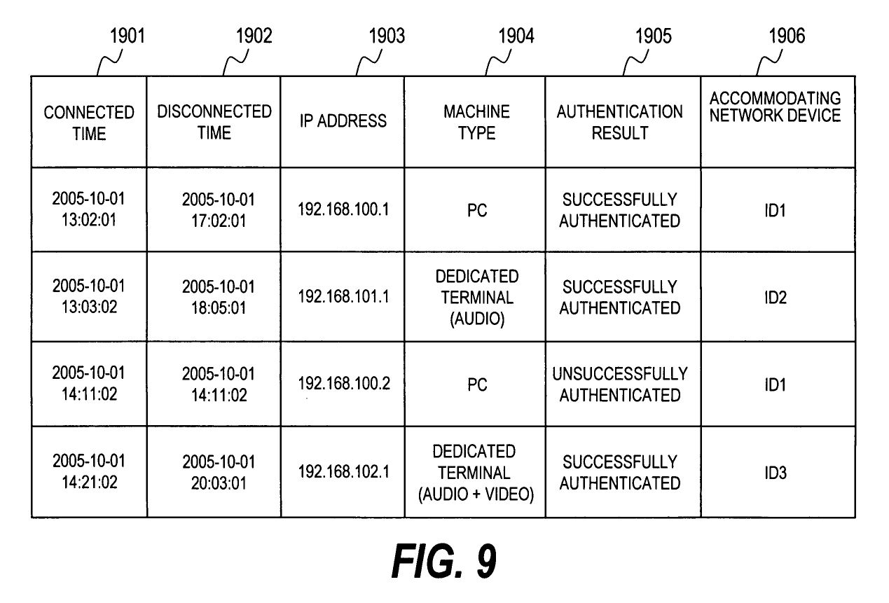

Next, the management device 500 requests an access log to the authentication server 700 (S105). Receiving the request, the authentication server 700 sends the access log to the management device 500 which has sent the request (S106). The access log sent here contains a time at which a terminal logs into the network, a time at which the terminal logs out of the network, the type of the terminal (machine type), the authentication result of the terminal (machine authentication result), and the like as shown in FIG. 9.

The management device 500 next sends the agent program 232 to the personal computer 230, and installs the agent program 232 (S107). The installed agent program 232 refers to information in the personal computer 230 and determines which flow this personal computer 230 uses. The determined flow is sent as PC terminal information to the management device 500 (S108).

The personal computer 230 may use, for example, “audio flows alone”, “audio flows and video flows”, or “other QoS guaranteeing flows than audio and video flows (e.g., a flow for an application relevant to a critical business operation)”.

The management device 500 calculates, from the access log received from the authentication server 700 and the PC terminal information received from the personal computer 230, how many personal computers use audio flows and video flows in each terminal group. The management device 500 also calculates how many dedicated terminals accommodated in each I/F of the network device 100 use audio flows and video flows (S109).

The management device 500 then creates settings for each I/F of the network device 100 in the setting target network 5 (S110). The management device 500 presents the created settings to the administrator and requests the administrator to confirm the settings (S111). The administrator confirms the presented settings (S112), and responds to the management device 500. Steps S111 and S112 may be omitted.

After the administrator confirms the settings, the management device 500 sends the created settings to the network device 100 in the setting target network 5 (S113). Upon reception of the settings, the network device 100 stores the received settings in itself, whereby setting is completed. The network device 100 then sends a setting completion confirmation message to the management device 500 which has sent the settings (S114). From then on, the network device 100 operates in accordance with these settings.

The management device 500 next sends the created settings to the personal computer 230 as request to set guaranteeing flow definition (S115). This request to set definition is received by the agent program 232 in the personal computer 230. The agent program 232 stores the received request to set definition in the disk device 2340, whereby setting is completed. The agent program 232 then sends a message to confirm the completion of setting of the definition information to the management device 500 which has sent the definition information (S116). From then on, the personal computer 230 adds identification information to a guaranteeing flow in accordance with this request to set guaranteeing flow definition.

FIGS. 8A to 8D show information exchanged between the management device 500 and the network device 100 or the personal computer 230. The information contains a message field 1801, a sender field 1802, a destination field 1803, and a details field 1804.

FIG. 8A is an explanatory diagram of an example of network device information that the network device 100 sends to the management device 500.

The network device information holds “network device information” in the message field 1801, (the address of the) “network device” in the sender field 1802, and (the address of the) “management device” in the destination field 1803. The details field 1804 of the network device information holds adjacent device information, I/F information, the count of priority levels that can be set by this network device 100, the line bandwidth of each link, and the like.

FIG. 8B is an explanatory diagram of an example of PC terminal information that the personal computer 230 sends to the management device 500.

The PC terminal information holds “PC terminal information” in the message field 1801, (the address of the) “PC terminal” in the sender field 1802, and (the address of the) “management device” in the destination field 1803. The details field 1804 of the PC terminal information holds information indicating flow used by the personal computer 230. Specifically, at least one of “audio flows alone”, “audio flows and video flows”, “other QoS guaranteeing flows than audio and video flows (e.g., a flow for an application relevant to a critical business operation)”, and “does not use any QoS guaranteeing flow” is stored in the details field 1804.

FIG. 8C is an explanatory diagram of an example of a setting request that the management device 500 sends to the network device 100.

The setting request holds “setting request” in the message field 1801, (the address of the) “management device” in the sender field 1802, and (the address of the) “network device” in the destination field 1803. The details field 1804 of the setting request holds a setting target I/F, the priority level of an audio flow, a CoS value for identifying an audio flow, the lowest guaranteed bandwidth of a video flow, a CoS value for identifying a video flow, and the like.

FIG. 8D is an explanatory diagram of an example of a guaranteeing flow definition setting request that the management device 500 sends to the personal computer 230.

The guaranteeing flow definition setting request holds “guaranteeing flow definition setting request” in the message field 1801, (the address of the) “management device” in the sender field 1802, and (the address of the) “PC terminal” in the destination field 1803. The details field 1804 of the guaranteeing flow definition setting request holds a CoS value for identifying an audio flow, a CoS value for identifying a video flow, and the like.

FIG. 9 is an explanatory diagram of an example of an access log that is sent to the management device 500 by the authentication server 700.

The access log contains a connected time field 1901, a disconnected time field 1902, an IP address field 1903, a machine type field 1904, an authentication result field 1905, and an accommodating network device field 1906.

The connected time field 1901 holds a time at which a machine to be authenticated has logged into the setting target network 5.

The disconnected time field 1902 holds a time at which the machine to be authenticated has logged out of the setting target network 5.

The IP address field 1903 holds the IP address of the machine to be authenticated.

The machine type field 1904 holds the type of the machine to be authenticated. Specifically, “PC terminal”, “dedicated terminal (audio)”, “dedicated terminal (video)”, or “normal terminal (a terminal that uses neither audio nor video)” is stored in the machine type field 1904.

The authentication result field 1905 holds the authentication result of the machine to be authenticated.

The accommodating network device field 1906 holds an identifier indicating to which network device 100 the machine to be authenticated is connected.

For example, FIG. 9 shows that the personal computer 230 whose IP address is 192. 168. 100. 1 has logged into the setting target network 5 on Oct. 1, 2005, at 13:02:01, and has successfully been authenticated. This personal computer 230 is accommodated by the network device 100 that has an identifier “ID1”, and has logged out of the network on Oct. 1, 2005, at 17:02:01.

The access log may not be information that is outputted explicitly as a log, and authentication result data which is internal management information of the authentication server 700 may be used as the access log.

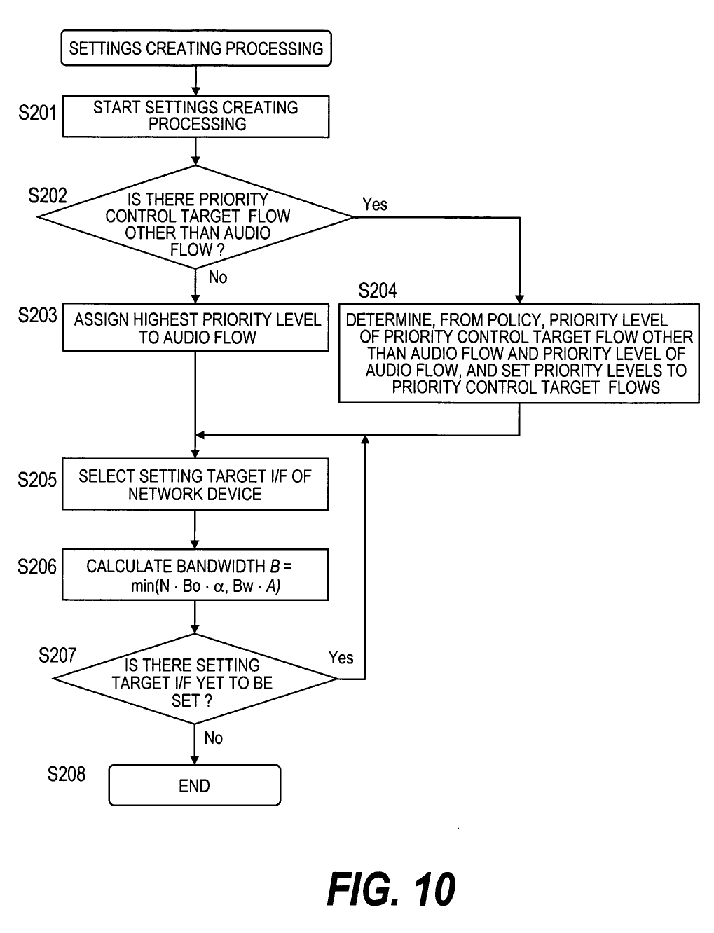

FIG. 10 is a flow chart for settings creating processing of the management device 500.

The management device 500 starts creating settings after calculating the number of the terminals (S201).

First, the management device 500 refers to the operation policy 552 to judge whether or not there are other flows than audio flows to be guaranteed of QoS (S202).

When it is judged that no other flows than audio flows are to receive priority control, the management device 500 assigns the highest priority level to audio flows (S203).

On the other hand, when it is judged that other flows than audio flows are to be guaranteed of QoS through priority control, the management device 500 refers to the operation policy 552 to determine the priority level of other priority control target flows than audio flows. The determined priority level is then set to the flows (S204).

Through the processing of Step S203 or S204, setting of priority levels to audio flows and other priority control target flows is finished.

After finishing setting up priority control, the management device 500 sets a guaranteed bandwidth to each I/F of the network device 100.

The management device 500 first chooses a setting target I/F (S205). Specifically, in order to set a guaranteed bandwidth for each of I/Fs (the input I/Fs 1040 and the output I/Fs 1060) of the network device 100 contained in the calculated topology, the management device 500 chooses one out of these I/Fs.

For the chosen I/F, the management device 500 obtains the number of the terminals N of terminals accommodated by this I/F, a bandwidth Bo occupied per communication session, the parameter α of a connection link, and a line bandwidth Bw of the connection link from the topology/number of terminals/device information 551, the operation policy 552, and the system parameter 553. Using the obtained values, the management device 500 determines a lowest guaranteed bandwidth B of a video flow of this I/F from the following expression:

B=min(N×Bo×α, Bw×A)

The parameter α is, as described above, stored in the system parameter 553. The parameter α has a value larger than 0 and equal to or smaller than 1. The parameter α is a parameter indicative of the network operation state such as the utilization ratio of a link, and is preset in the management device 500 upon construction of the internal network 1. Alternatively, the administrator may determine the value of α arbitrarily through the GUI of the management device 500.

The management device 500 compares a value obtained by multiplying number of the terminals N, the bandwidth Bo and the parameter α(N×Bo×α) with a value obtained by multiplying the connection link line bandwidth Bw and a constant A (Bw×A). The management device 500 determines the smaller value of the two as the lowest guaranteed bandwidth of this I/F (S206).

Determining the bandwidth in this manner makes it possible to prevent a video flow from occupying all of the line bandwidth of a connection link.

The management device 500 next judges whether or not there is an I/F for which the bandwidth has not been determined yet (S207). When there is an I/F yet to be set, the management device 500 returns to Step S206 and executes the setting processing for this I/F. When it is judged that every I/F of the network device 100 has been set, the setting processing is ended, whereby the processing according to the flow chart of FIG. 10 is completed (S208).

Through the above processing, settings specific to each I/F of the network device 100 are created.

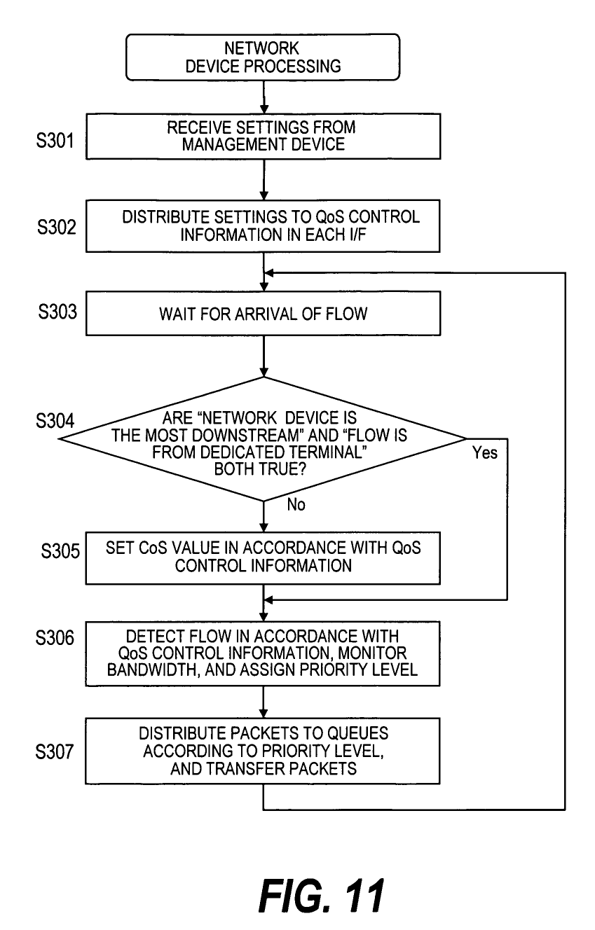

FIG. 11 is a flow chart for processing of the network device 100.

The processing of this flow chart is started when the operation control unit 1010 in the network device 100 receives, via the input I/Fs 1040, settings that are sent from the management device 500 (S301).

First, the operation control unit 1010 divides the received settings into settings of the respective I/Fs. The divided settings are distributed to the QoS control information holding units 1041 or 1061 of the respective I/Fs.

Processing of setting each I/F is thus completed.

The following description is about how the network device 100 operates upon arrival of a flow.

The network device 100 waits for the arrival of a flow (S303). Receiving a flow via one of the input I/Fs 1040, the network device 100 executes the following processing.

First, the flow detecting unit 1042 judges whether or not this network device 100 is connected to a terminal without the intervention of one or more network devices capable of QoS control, in other words, this network device 100 is the most downstream network device among the network devices 100 within the internal network 1 that are capable of QoS control, and the received flow is a flow sent from the dedicated terminal 210 or 220 (S304).

When it is judged that this network device 100 is the most downstream of the network and at the same time the received flow is a flow sent from one of the dedicated terminals, the CoS value setting unit 1043 in this input I/F 1040 sets a CoS value that has been attached to a packet of the received flow in accordance with the QoS control information 1041 (S305).

This is because, unlike the personal computer 230, neither the dedicated terminal 210 nor 220 has a function of attaching a CoS value that is set by the management device 500 in accordance with the flow. In other words, a flow sent by the dedicated terminal 210 or 220 is analyzed by the network device 100 that is immediately upstream of the dedicated terminal, and the network device 100 sends the flow to the network after setting the CoS value with a value that is associated with this flow. In this way, a flow sent by the dedicated terminal 210 or 220 can have a CoS value set by the management device 500, as does a flow sent by the personal computer 230.

On the other hand, when it is judged that this network device 100 is not the most downstream of the network or that the received flow is not a flow sent from one of the dedicated terminals, the processing moves to Step S306 without executing Step S305.

The flow detecting unit 1062 in one of the output I/Fs 1060 judges from information stored in the QoS control information holding unit 1061 whether or not the entered flow is a QoS guaranteeing flow. When the entered flow is a QoS guaranteeing flow, the bandwidth is monitored and a priority level is assigned to this flow (S306).

Packets of this flow are then distributed to the queues 1065 in accordance with the assigned priority level. The packets stored in the queues 1065 are then sent out (S307).

The network device 100 controls a QoS guarantee through the above processing.

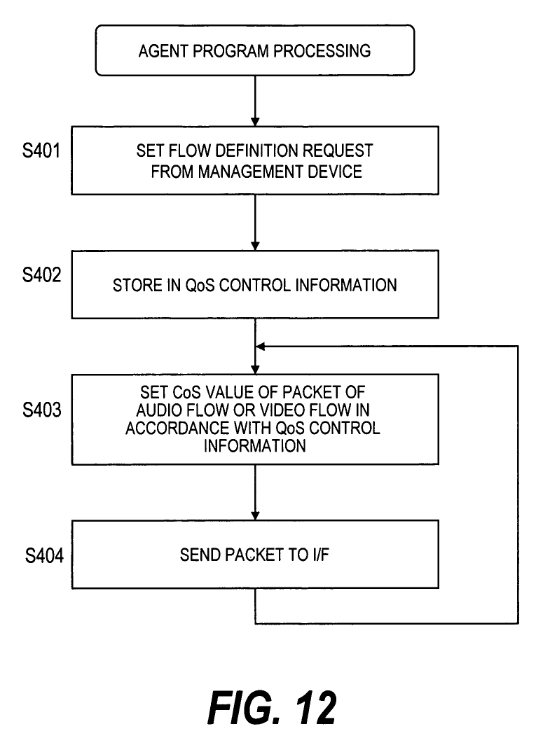

FIG. 12 is a flow chart for processing of the agent program 232 in the personal computer 230.

The management device 500 sends a guaranteeing flow definition request (Step S115 in FIG. 7). The agent program 232 in the personal computer 230 receives the guaranteeing flow definition request sent from the management device 500, and starts the processing of this flow chart (S401).

First, the agent program 232 stores the received guaranteeing flow definition request in the QoS control information 231 of the disk device 2340 (S402).

From then on, the agent program 232 transmits a flow in accordance with this QoS control information 231.

In the case where a request to send an audio flow or a video flow is received, the agent program 232 sets the CoS value of the packet of the audio flow or video flow in accordance with the QoS control information 231 (S403).

The agent program 232 then sends packets of the audio flow or the video flow to the I/F 2320 (S404). The packets are sent from the I/F 2320.

The above processing enables the personal computer 230 to send and receive flows guaranteed of QoS.

The description given next is about settings created by the management device 500.

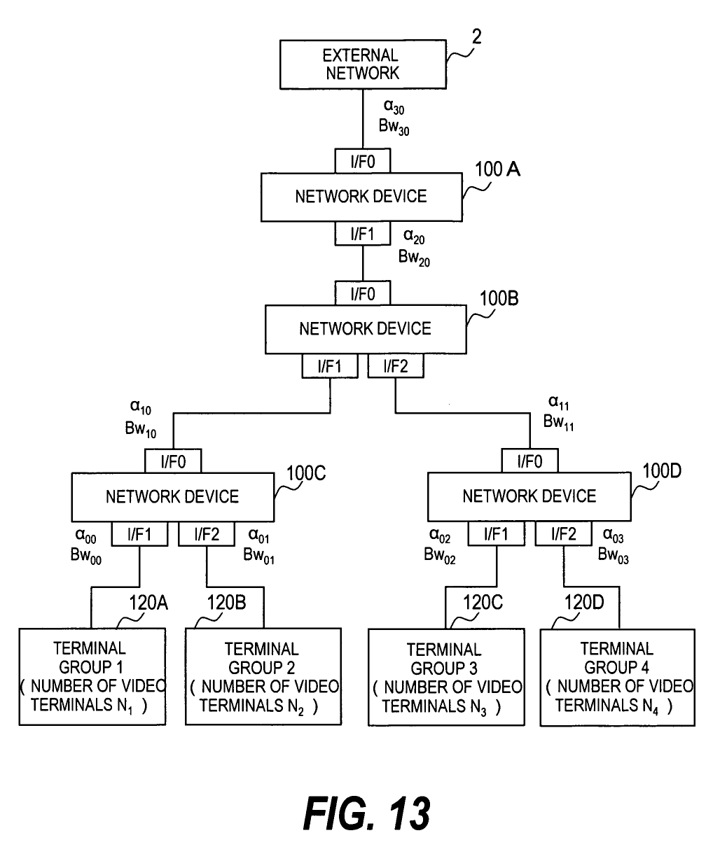

FIG. 13 is an explanatory diagram showing an example of settings calculated for each I/F of the network device 100 with respect to a topology that is managed by the management device 500.

For example, FIG. 13 shows that an I/F 1 of the network device 100A is connected to an I/F 0 of the network device 100B, and that α and Bw between these I/Fs are set to “α₂₀” and “Bw₂₀”, respectively.

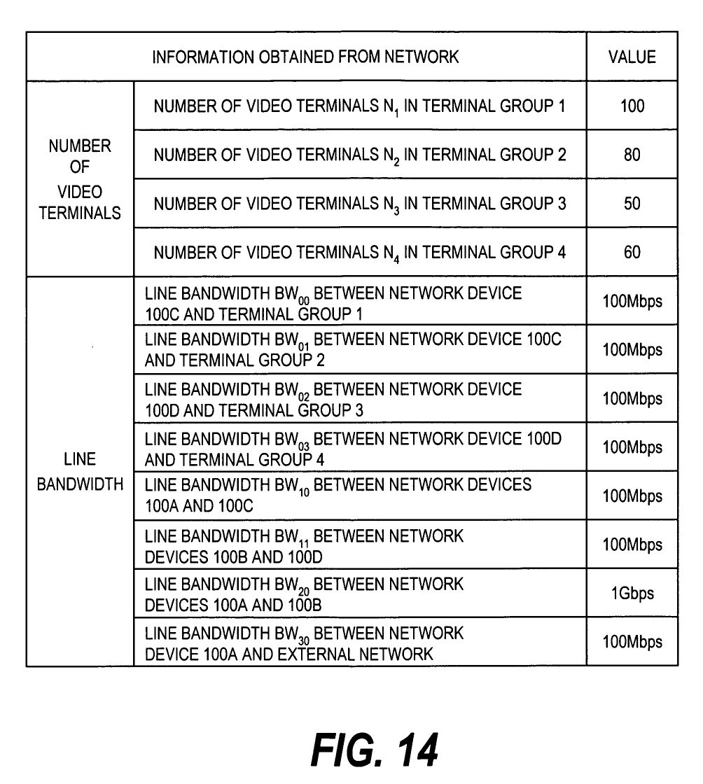

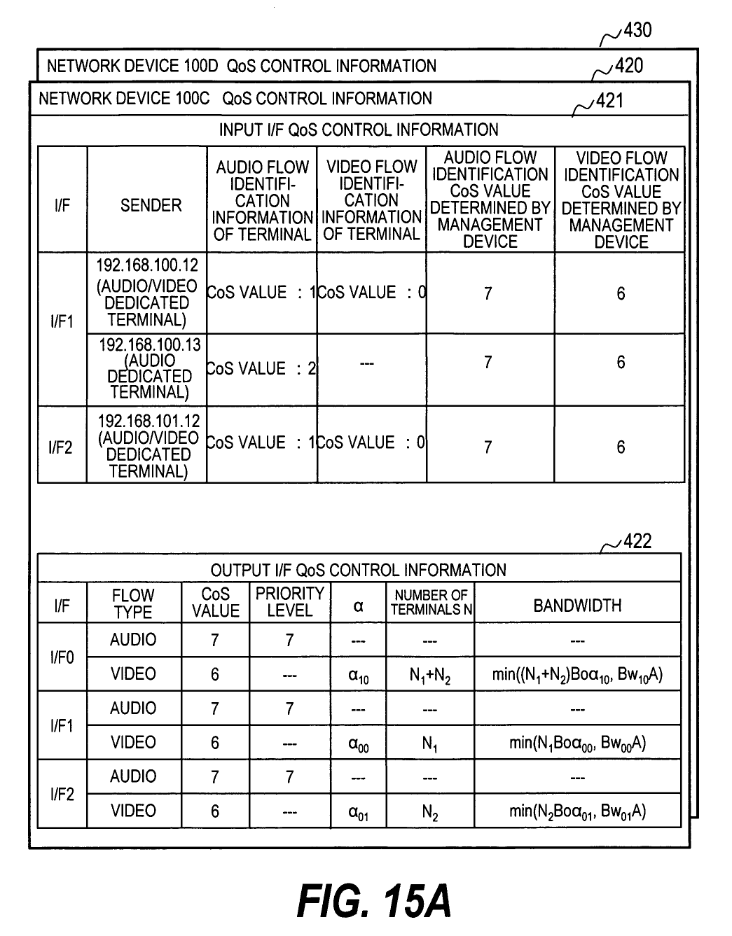

FIG. 14 is an explanatory diagram of an example of the number of the terminals calculated by the management device 500.

FIG. 14 shows the number of terminals information obtained from the authentication server 700 and information obtained as network device information from each network device 100 that is contained in the internal network 1 by the management device 500.

For example, FIG. 14 shows that, with regard to number of a video terminals, “100” is obtained by the management device 500 as the number of a video terminals N₁ in the terminal group 1. Similarly, with regard to a line bandwidth, “1 Gbps” is obtained as the value of a line bandwidth Bw₂₀ between the network devices 100A and 100B.

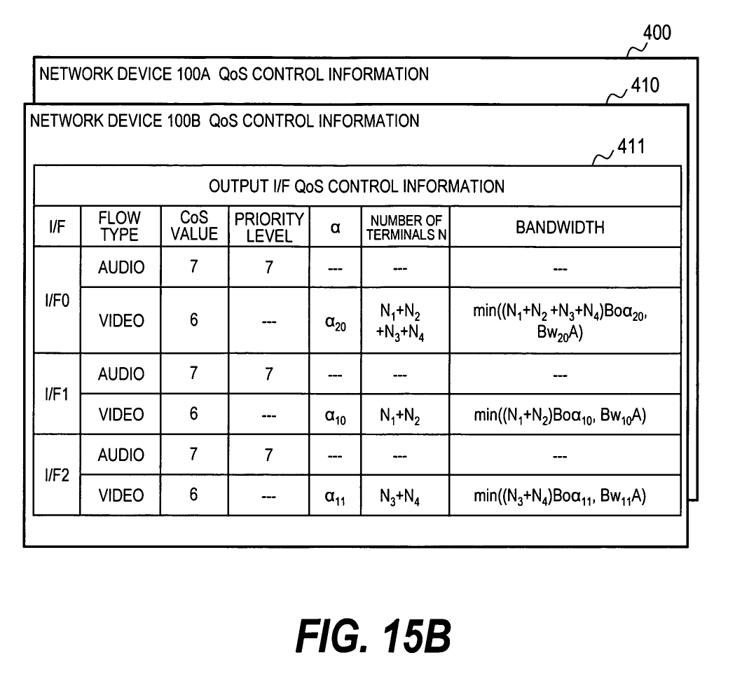

FIGS. 15A and 15B are explanatory diagrams showing an example of QoS control information as settings created by the management device 500.

The management device 500 creates QoS control information for each network device 100 through the settings creating processing, which has been described above with reference to FIG. 10.

The QoS control information created here by the management device 500 are QoS control information 421 of input I/Fs and QoS control information 422 of output I/Fs shown in FIG. 15A, in the case where the network device 100 to be set is connected to a terminal without the intervention of one or more network devices 100 capable of QoS control, in other words, when this network device 100 is the most downstream network device among the network devices 100 within the internal network 1 that are capable of QoS control.

As mentioned above, neither the dedicated terminal 210 nor 220 can set an arbitrary CoS value that is set by the management device 500. The network device 100 immediately upstream of the dedicated terminal 210 or 220 therefore sets the CoS value of a flow sent from the dedicated terminal to a CoS value set by the management device 500.

For instance, in the I/F 1, an audio and video dedicated terminal which has an IP address 192. 168. 100. 12 sets the CoS value of a flow to 1 when the flow is an audio flow and to 0 when the flow is a video flow, and then sends the flow. Receiving the flow from this dedicated terminal, the network device 100C sets the CoS value to 7 when the received flow is an audio flow and to 6 when the received flow is a video flow.

In the case where the network device 100 to be set is connected to a dedicated terminal via one or more network devices 100 capable of QoS control, the only QoS control information created by the management device 500 is QoS control information 411 of output I/Fs as shown in FIG. 15B.

The QoS control information 421 of input I/Fs contains a sender IP address of a dedicated terminal accommodated by each I/F, a CoS value that is used by the dedicated terminal to identify an audio flow, a CoS value that is used by the dedicated terminal to identify a video flow, a CoS value that is determined by the management device 500 and used to identify an audio flow, and a CoS value that is determined by the management device 500 and used to identify a video flow.

The QoS control information 422 for output I/Fs contains for each I/F a flow type, a CoS value for discriminating audio flows from video flows, a priority level set to audio flows, the parameter α, the number of the terminals N of dedicated terminals that handle video and are accommodated by the I/F, and a set value of the bandwidth of the video flow.

The management device 500 sets these pieces of QoS control information for each network device 100.

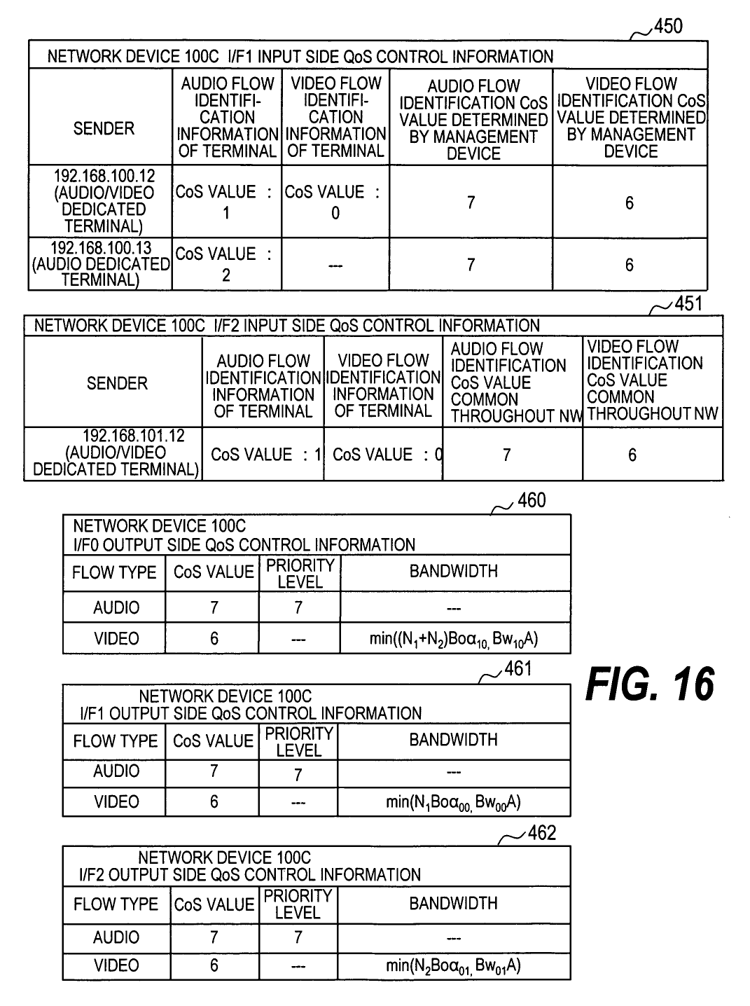

FIG. 16 is an explanatory diagram of an example of QoS control information that is held by the respective I/Fs of the network device 100.

Settings created by the management device 500 are sent to the network device 100 as a setting request (Step S113 of FIG. 7). Receiving the setting request, the network device 100 stores, in the respective I/Fs, QoS control information that is contained in the setting request.

Pieces of input I/F QoS control information 450 and 451 each contain the IP address of a sender which is a dedicated terminal accommodated by an I/F, information used by the terminal to identify an audio flow, information used by the terminal to identify a video flow, information that is determined by the management device 500 and used to identify an audio flow, and information that is determined by the management device 500 and used to identify a video flow.

Pieces of output I/F QoS control information 460, 461, and 462 each contain a flow type, a CoS value for discriminating audio flows from video flows, a priority level attached to audio flows, and a bandwidth that is a set value.

The GUI of the management device 500 will be described next.

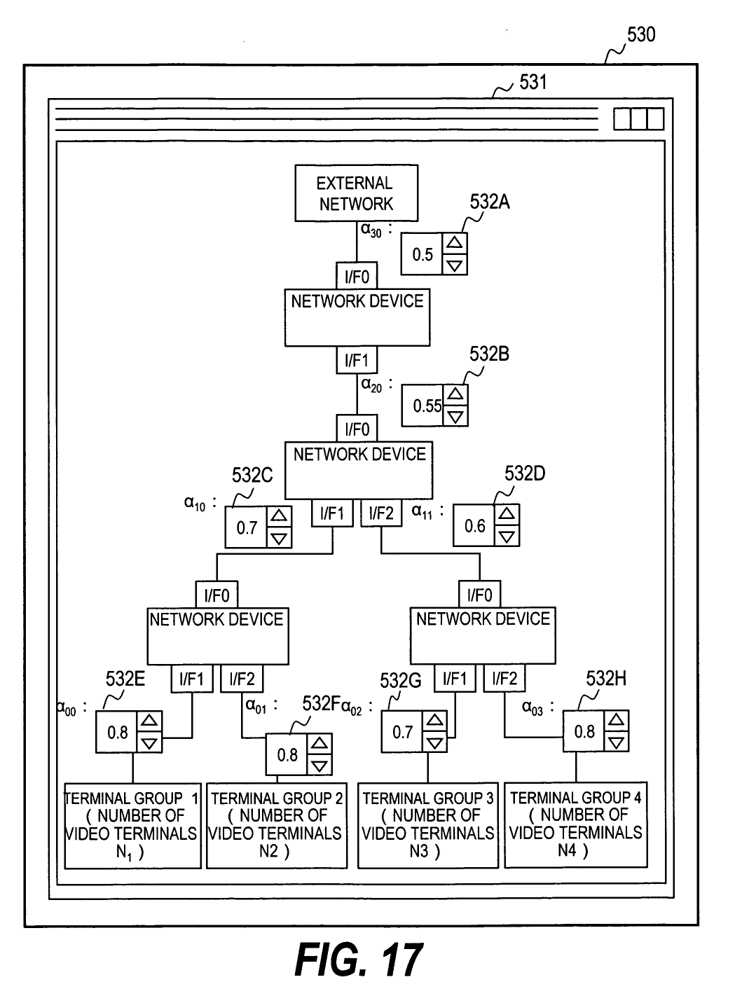

FIG. 17 is an explanatory diagram of an example of a GUI screen of the management device 500.

A screen 530 of the user interface 511 in the management device 500 displays a GUI 531 through which the parameter α can be entered.

The GUI 531 displays a network topology that the management device 500 obtains from the network and a for each link in the topology. The GUI 531 has input/output fields 532 (532A, 532B, 532C, 532D, 532E, 532F, 532G, and 532H) with which a can be changed.

The GUI 531 enables the administrator of the internal network 1 to check the value of α, and to change the value of α so that the intention of the administrator is reflected.

Described next is how the management device 500 operates when the network management system is in operation.

The sequence described above with reference to FIG. 7 puts the network management system into operation. While the network management system is in operation, the management device 500 executes the following processing.

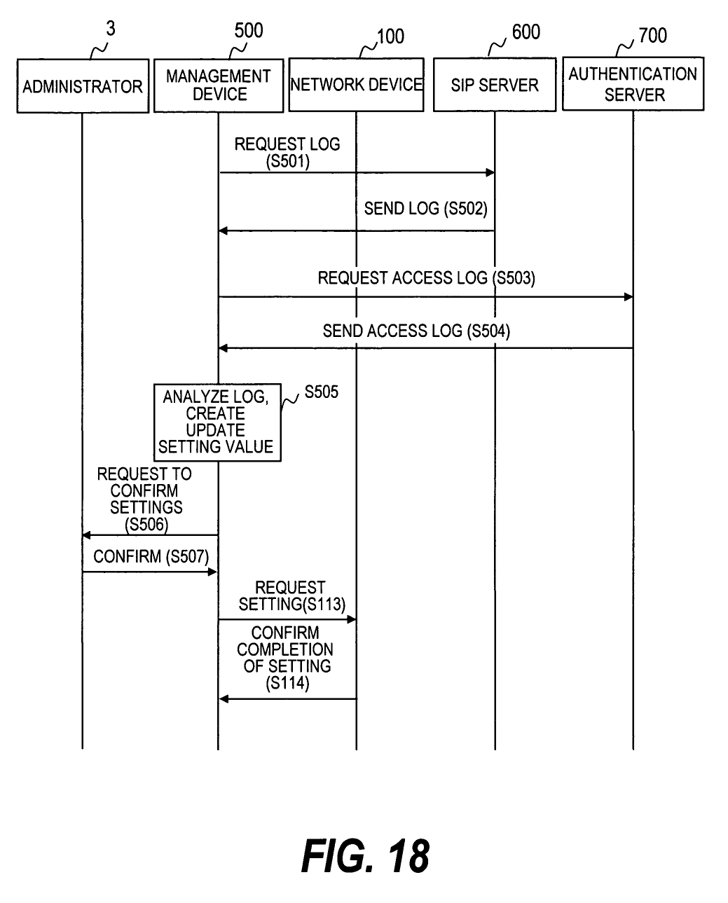

FIG. 18 is a sequence diagram of when the network management system is in operation.

The management device 500 refers to the settings update execution time contained in the system parameter 553. When the current time reaches the settings update execution time, the management device 500 executes a settings update operation shown in FIG. 18.

In the case where the system parameter 553 is set as shown in FIG. 3, for example, the management device 500 starts the processing of this flow chart every day at 4:00.

First, the management device 500 requests a log from the SIP server 600 (S501). Receiving the log request, the SIP server 600 sends a session log of the SIP server 600 to the management device 500 which has sent the request (S502).

Next, the management device 500 requests an access log from the authentication server 700 (S503). Receiving the request, the authentication server 700 sends the access log to the management device 500 which has made the request (S504).

From the log received from the SIP server 600 and the access log received from the authentication server 700, the management device 500 creates settings values with which the current settings are to be updated for each I/F of the network device 100 in the setting target network 5 (S505).

The management device 500 presents the created settings to the administrator and requests the administrator to confirm the settings (S506). The administrator confirms the settings (S507) and responds to the management device 500. Steps S506 and S507 may be omitted.

After the administrator confirms the settings, the management device 500 sends the created settings to the network device 100 in the setting target network 5 (S508). Upon reception of the settings, the network device 100 stores the received settings in itself, whereby setting is completed. The network device 100 then sends a setting completion confirmation message to the management device 500 which has sent the settings (S509). From then on, the network device 100 operates in accordance with these settings.

Thus, even when the system is in operation, the management device 500 obtains a session log of the SIP server 600 and the number of the terminals to calculate new settings based on the obtained session log and the number of the terminals. The network device 100 performs QoS guarantee control in accordance with the new calculated settings.

In the manner described above, settings can be changed taking into account the past operation state of the system.

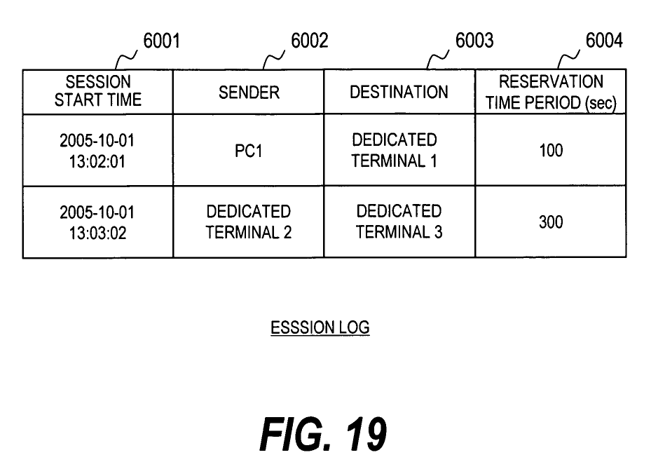

FIG. 19 is an explanatory diagram of an example of the session log that the SIP server 600 sends to the management device 500.

The session log contains a session start time field 6001, a sender field 6002, a destination field 6003, and a reservation time period field 6004.

The session start time field 6001 holds a time at which a session is started. The sender field 6002 holds (the address on a terminal that has an identification of sender terminal via the session. The destination field 6003 holds (the address on an identification of destination terminal via the session. The reservation time period field 6004 holds the session reservation time.

The session log may not be information that is outputted explicitly as a log, and established session data which is internal management information of the SIP server 600 may be used as the session log.

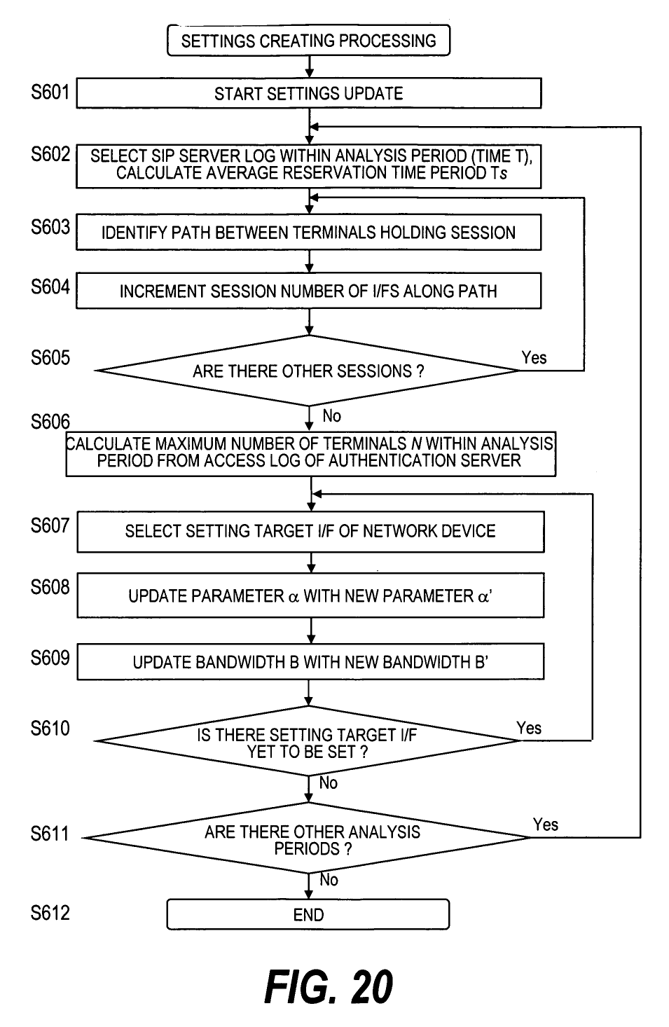

FIG. 20 is a flow chart for settings updating processing of the management device 500.

The management device 500 starts the processing of this flow chart after obtaining a log from the SIP server 600 and an access log from the authentication server 700 (S601).

First, the management device 500 selects, from the log obtained from the SIP server 600, log entries within an analysis period set in the system parameter 553. From the selected log entries, an average reservation time period Ts is calculated (S602).

In the case where the system parameter 553 is set as shown in FIG. 3, for example, the management device 500 selects log entries between 0:00 and 8:00, between 8:00 and 12:00, and between 12:00 and 0:00 from the obtained log.

From the selected log entries, the management device 500 identifies a path between terminals where a communication session is held (S603). The management device 500 then increments a communication session count counter of an I/F along the identified path by 1 (S604).

The management device 500 judges whether or not there are other communication sessions (S605). When it is judged that there are other communication sessions, the management device 500 executes the processing of Steps S603 and S604.

Through this processing, the management device 500 calculates the session count of each I/F with respect to all communication sessions within the analysis period.

The management device 500 next selects, from the access log obtained from the authentication server 700, access log entries within an analysis period set in the system parameter 553. From the selected access log entries, a maximum number of the terminals N is calculated to obtain the maximum number of terminals that have concurrently been in use within the analysis period (S606).

The management device 500 creates settings from the calculated session count and maximum number of the terminals count N.

First, the management device 500 chooses one setting target I/F of the network device 100 (S607). For the chosen I/F, the parameter α is calculated by the following expression to obtain a new parameter α′ (S608):

α′=(M×Ts)/(N×T)

Next, using the obtained parameter α″, the management device 500 updates the lowest bandwidth B by the following expression, and obtains a new lowest bandwidth B′ (S609):

B′=min(N×Bo×α′, Bw×A)

The management device 500 then judges whether or not there is a setting target I/F that has not been set yet (S610). Judging that there is an I/F yet to be set, the management device 500 returns to Step S608 to calculate the new parameter α′ and the new lowest bandwidth B′ for this setting target I/F.

Thereafter, the management device 500 judges whether or not another analysis period is set in the system parameter 553 (S611). Judging that there is another analysis period, the management device 500 returns to Step S602, where processing is executed for this analysis period and settings are created.

Through the above processing, the management device 500 creates new settings from the session count and the number of the terminals that are calculated for each analysis period, and updates the current settings with the new settings.

As described, when the network is in operation, the management device 500 updates the settings in accordance with the operation state of the network, thereby efficiently using bandwidth resources. In addition, the management device 500 updates the settings regularly at a designated time, which makes it possible to avoid a situation in which each new communication session produces processing and to avoid burdening the network management device with heavy load.

The description given next is about how the system operates after a change in network configuration.

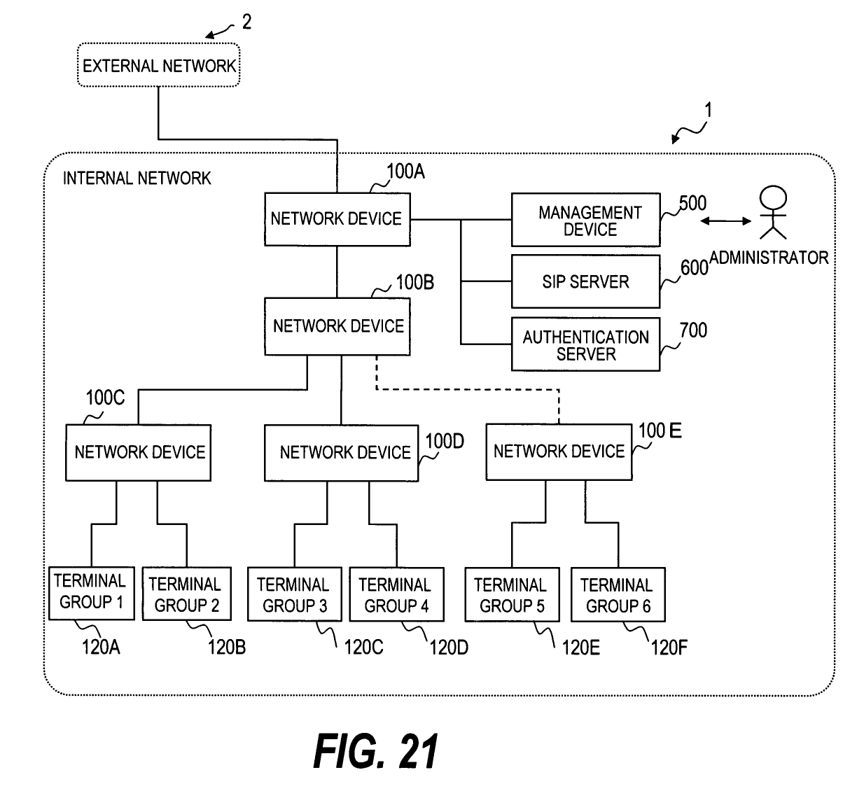

FIG. 21 is a configuration block diagram of a network management system, which is obtained by changing the network configuration in FIG. 1.

By expanding the network, a network device 100E and a terminal group 120E and a terminal group 120F which are accommodated by the network device 100E are added.

In this case, when the operation policy 552 is set such that a change in network configuration is accompanied by automatic updating of QoS guarantee settings, the management device 500 detects a change in network configuration, creates new settings from the changed network configuration (including changing network topology and replacing network device) and the number of the terminals, and updates the current settings with the new settings.

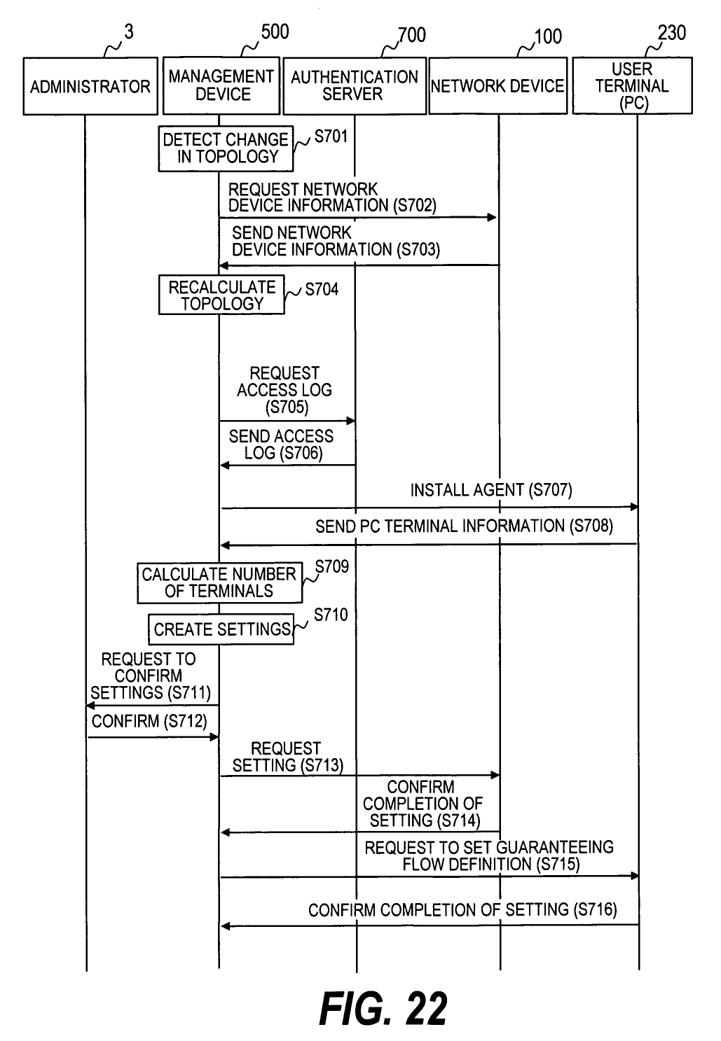

FIG. 22 is a sequence diagram of the network management system after a change in configuration.

When the operation policy 552 is set such that a change in network configuration is accompanied by automatic updating of QoS guarantee settings (for example, when a policy of number “3” in FIG. 3 is employed), the management device 500 executes settings updating processing that is due to a topology change such as addition of a new network device 100.

First, the management device 500 detects a change in topology (S701). A topology change may be detected from information sent by the added network device 100, or from multi-cast transmission of a request sent regularly by the management device 500 to catch a topology change.

Detecting a topology change, the management device 500 requests network device information from the network device 100 (S702). The network device 100 that has received this request sends the requested network device information to the management device 500 (S703).

Next, the management device 500 recalculates the topology from the received network device information (S704). The calculated topology is stored in the disk device 530.

The management device 500 next requests an access log from the authentication server 700 (S705). Receiving the request, the authentication server 700 sends the access log to the management device 500 (S706).

The management device 500 refers to the calculated topology and device information that has been kept to select the personal computer 230 where the agent program 232 has not been installed yet. The management device 500 then installs the agent program 232 in the selected personal computer 230 (S707). The installed agent program 232 sends PC terminal information to the management device 500 (S708).

Next, from the access log received from the authentication server 700 and the PC terminal information received from the personal computer 230, the management device 500 calculates how many personal computers in each terminal group use audio flows and video flows. The management device 500 also calculates how many dedicated terminals that are accommodated by each I/F of the network device 100 use audio flows and video flows (S709).

The management device 500 then creates settings for each I/F of the network device 100 in the setting target network 5 (S710). The settings are created through the processing described above with reference to FIG. 10. The management device 500 presents the created settings to the administrator, and requests the administrator to confirm the settings (S711). The administrator confirms the settings (S712) and responds to the management device 500. Steps S711 and S712 may be omitted.

After the administrator confirms the settings, the management device 500 sends the created settings to the network device 100 in the setting target network 5 (S713). Upon reception of the settings, the network device 100 stores the received settings in itself, whereby setting is completed. The network device 100 then sends a setting completion confirmation message to the management device 500 which has sent the settings (S714). From then on, the network device 100 operates in accordance with these settings.

The management device 500 next sends the created guaranteeing flow definition information to the personal computer 230 (S715). This definition information is received by the agent program 232 in the personal computer 230. The agent program 232 stores the received definition information in the disk device 2340, whereby setting is completed. The agent program 232 then sends a message to confirm the completion of setting of the definition information to the management device 500 which has sent the definition information (S716). From then on, the personal computer 230 adds identification information to a guaranteeing flow in accordance with this guaranteeing flow definition information.

Through the above processing, the management device 500 detects a topology change and automatically updates QoS guarantee settings even when the network configuration is changed.

While the present invention has been described in detail and pictorially in the accompanying drawings, the present invention is not limited to such detail but covers various obvious modifications and equivalent arrangements, which fall within the purview of the appended claims.

What is claimed is:

1. A management device, which is included in a network system that contains at least one terminal that sends and receives at least one of audio data and video data as a data flow, and at least one network device that transfers the data flow sent and received by the terminals while guaranteeing QoS of the data flow, and which manages QoS guarantee control that is executed by the network devices, the management device comprising:
a control unit; and
a storage unit,
wherein the control unit is configured to:
obtain the number of terminals contained in the network system and connection relations in the network system when QoS control is about to start in the network system;
store, in the storage unit, an operation policy entered by an administrator;
use the number of terminals in the network system, the connection relations, and the operation policy to create, for each of a connection path between adjacent two of the network devices or for each of a connection path between one of the network devices and one of the terminals that is adjacent to the network device, QoS control information for controlling the QoS guarantee that is executed by the network devices; and
set the created QoS control information in the network devices.

2. The management device according to claim 1, wherein, in creating QoS control information, the control unit gives different characteristics to QoS control information for the audio data and QoS control information for the video data.

3. The management device according to claim 1,
wherein the network system has an authentication server which performs authentication before the terminals log into the network, and
wherein the control unit is configured to:
obtain, from the authentication server, a log of the terminals logging into the network;
obtain, from each terminal, information of a data flow that is to be guaranteed of QoS and used by the terminal; and
use the obtained log and the obtained data flow information to calculate for each of a connection path between adjacent two of the network devices or for each of a connection path between one of the network devices and one of the terminals that is adjacent to the network device, the number of terminals using the connection path.

4. The management device according to claim 1,
wherein the network system has an SIP server which establishes communication sessions between the terminals, and
wherein the control unit is configured to:
obtain a log of communication sessions from the SIP server;
use the obtained communication session log, the number of terminals in the network system, the connection relations, and the operation policy to create QoS control information for controlling the QoS guarantee that is executed by the network devices; and
set the created QoS control information in the network devices.

5. The management device according to claim 4,
wherein the storage unit stores a settings update time and at least one analysis period, and
wherein, when the settings update time is reached, the control unit is configured to:
obtain the communication session log from the SIP server;
select log entries of the communication session log that are within the analysis periods;
use the selected log entries, the number of terminals in the network system, the connection relations, and the operation policy to create QoS control information for controlling the QoS guarantee that is executed by the network devices; and
set the created QoS control information in the network devices.

6. The management device according to claim 1, wherein, when the control unit detects a configuration change in the network system, the control unit is configured to:
obtain the number of terminals contained in the network system and connection relations in the network system;
use the number of terminals in the network system, the connection relations, and the operation policy to create, for each of a connection path between adjacent two of the network devices or for each of a connection path between one of the network devices and one of the terminals that is adjacent to the network device, QoS control information for controlling the QoS guarantee that is executed by the network devices; and
set the created QoS control information in the network devices.

7. A network system, comprising:
at least one terminal which sends and receives at least one of audio data and video data as a data flow;
at least one network device which transfers the data flow sent and received by the terminals while guaranteeing QoS of the data flow; and
a management device which manages QoS guarantee control that is executed by the network devices,
wherein the management device has a control unit and a storage unit, wherein the control unit is configured to:
determine, for each data flow that is to be guaranteed of QoS, flow identification information which is an identifier of the data flow;
create, for each of a connection path between adjacent two of the network devices or for each of a connection path between one of the network devices and one of the terminals that is adjacent to the network device, QoS control information for controlling the QoS guarantee that is executed by the network devices, the QoS control information containing the flow identification information;
set the created QoS control information in the network devices;
install, to each terminal, an agent which has a function of attaching the data flow identification information to a data flow that is sent by the terminal; and
set the determined flow identification information in the terminals,
wherein the terminals attach the flow identification information to corresponding data flows and send the data flows, and
wherein the network devices attach the flow identification information to corresponding data flows and transfer received data flows.

8. A network system, comprising:
at least one terminal which sends and receives at least one of audio data and video data as a data flow;
at least one network device which transfers the data flow sent and received by the terminals while guaranteeing QoS of the data flow;
a management device which manages QoS guarantee control that is executed by the network devices;
an authentication server which performs authentication before the terminals log into the network; and
an SIP server which establishes communication sessions between the terminals,
wherein the management device has a control unit and a storage unit, and
wherein the control unit is configured to:
obtain the number of terminals contained in the network system and connection relations in the network system when QoS control is about to start in the network system;
store, in the storage unit, an operation policy entered by an administrator;
use the number of terminals in the network system, the connection relations, and the operation policy to create, for each of a connection path between adjacent two of the network devices and a connection path between one of the network devices or for each of one of the terminals that is adjacent to the network device, QoS control information for controlling the QoS guarantee that is executed by the network devices; and
set the created QoS control information in the network devices.

9. The network system according to claim 8, wherein, in creating QoS control information, the control unit gives different characteristics to QoS control information for the audio data and QoS control information for the video data.

10. The network system according to claim 8, wherein the control unit is configured to:
obtain, from the authentication server, a log of the terminals logging into the network;
obtain, from each terminal, information of a data flow that is to be guaranteed of QoS and used by the terminal; and
use the obtained log and the obtained data flow information to calculate, for each of a connection path between adjacent two of the network devices or for each of a connection path between one of the network devices and one of the terminals that is adjacent to the network device, the number of terminals using the connection path.

11. The network system device according to claim 8, wherein the control unit is configured to:
obtain a log of communication sessions from the SIP server;
use the obtained communication session log, the number of terminals in the network system, the connection relations, and the operation policy to create QoS control information for controlling the QoS guarantee that is executed by the network devices; and
set the created QoS control information in the network devices.

12. The network system according to claim 11,
wherein the storage unit stores a settings update time and at least one analysis period, and
wherein, when the settings update time is reached, the control unit is configured to:
obtain the communication session log from the SIP server;
select log entries of the communication session log that are within the analysis periods;
use the selected log entries, the number of terminals in the network system, the connection relations, and the operation policy to create QoS control information for controlling the QoS guarantee that is executed by the network devices; and
set the created QoS control information in the network devices.

13. The network system according to claim 8, wherein, when the control unit detects a configuration change in the network system, the control unit is configured to:
obtain the number of terminals contained in the network system and connection relations in the network system;
store, in the storage unit, an operation policy entered by an administrator;
use the number of terminals in the network system, the connection relations, and the operation policy to create, for each of a connection path between adjacent two of the network devices or for each of a connection path between one of the network devices and one of the terminals that is adjacent to the network device, QoS control information for controlling the QoS guarantee that is executed by the network devices; and
set the created QoS control information in the network devices.
